(19) United States
(12) Patent Application Publication
(10) Pub. No.: US 2010/0120947 A1
(43) Pub. Date: May 13, 2010

(54) Biaxially stretched polyester film which comprises a chain extender, and process for production thereof and use thereof

(76) Inventors: Bodo Kuhmann, Runkel (DE); Holger Kliesch, Ginsheim (DE); Dagmar Klein, Ockenheim (DE); Martin Jesberger, Mainz (DE); Thomas Hackl, Huenstetten (DE)

Correspondence Address: PROPAT, L.L.C., 425-C SOUTH SHARON AMITY ROAD, CHARLOTTE, NC, 28211-2841, US

(21) Appl. No.: 12/384,295

(22) Filed: Apr. 2, 2009

(30) Foreign Application Priority Data
Nov. 11, 2008 (DE) 10 2008 056 694.2

(51) Int. Cl. C08L 63/00; C08L 67/02; B29C 47/00

(52) U.S. Cl. 523/400; 525/437; 524/605; 525/438; 264/210.1

(57) ABSTRACT

The invention relates to biaxially oriented polyester films that include a chain extender in addition to polyester. Such films find use in all applications typical of biaxially oriented polyester films, especially in outdoor applications, as a ribbon cable, as a backside laminate of solar modules and in electrical insulation applications.

The invention relates a biaxially stretched film composed of a polyester whose thickness is preferably within the range from 6 to 500 μm. The film comprises at least one chain extender and is notable, by virtue of its good producibility, for a low gel level, a good hydrolysis stability and a low impairment of the other film properties by the chain extender. The invention further relates to a process for producing the film and to the use thereof.

Biaxially stretched films composed of polyesters within the thickness range specified are sufficiently well known.

The production of such polyester films always gives rise to production residues (e.g. edge offcuts), which, as a result of the process, are almost never less than 10% by weight of the material used and typically correspond to 30-70% by weight of the amount of raw material used.

Typically, these amounts are reground and reused. In this context, “reground” means that the residues are chopped, melted in an extruder and pelletized, and then sent back to the process in the form of this pellet material.

In each extrusion step (film production and each regrind), the polyester typically loses chain length, which is reflected in a lower viscosity of the regrind.

The loss of chain length is caused by the hydrolytic cleavage of the chains and shearing in the extrusion.

For the production of biaxially stretched polyester films, however, a sufficient chain length and hence viscosity is needed, since there are otherwise for example when the viscosity is lower, film breakoffs and a resulting deterioration in economic viability.

An additional factor is that the more stable the viscosity of the melt is over time, the less disruption there is to production. It is therefore unfavorable when raw materials of very different viscosity are mixed, since there may thus be randomly varying conditions in the region of the extrusion in the process.

Both factors limit the maximum amount of useable regrind. It would therefore be desirable if the viscosity of the regrinds were at about the level of the original raw materials used.

An increase in the viscosity, especially during the extrusion, might be achieved by the use of chain extenders.

Chain extenders for polyesters are likewise known and are described, for example, in EP-A-1 054 031. This publication describes the use of anhydrides, especially pyromellitic anhydride, as an effective constituent of the inventive formulation.

Chain extenders for PET which are based on oxazolines or caprolactams are sold by DSM (the Netherlands) under the Allinco® brand name.

Chain extenders with epoxy functions are described, inter alia, in U.S. Pat. No. 6,984,694 and are commercially available under the Joncryl® brand name from BASF (Germany).

Polymers with glycidyl end groups which are likewise suitable in principle as chain extenders for PET are sold under the Epon® brand name by Hexion (USA) or the Lotader® brand name by Arkema (France).

Even though they are well known, as described above, chain extenders in industrial practice have to date found no significant use in the production of biaxially stretched polyester films.

One reason for this lies in the tendency of the chain extenders to form gels. A gel here is a polymer with a degree of crosslinking which distinguishes it mechanically so greatly from the surrounding polymer that it can no longer take a full part in the stretching process and behaves similarly to a large particle in the film. In unstretched polyester films or injection moldings, these are relatively uncritical and, on attainment of extreme sizes, are at worst visually unappealing under some circumstances and can therefore lead to rejects. In stretched polyester films, however, they have much more serious effects, since such films are usually manufactured in thicknesses below 400 μm and even small gel particles not only become visible at the surface but can also lead to breakoffs in the stretching process.

Further disadvantages may be a rise in the yellowness index, deposits on rollers in the production process or else a reduced hydrolysis stability of the extended polyester chains. The latter point then leads to the effect that the viscosity rise obtained by the chain extender is lost all the more rapidly in the downstream extrusion.

It is thus an object of the present invention to provide a polyester film which avoids the described disadvantages of the prior art. The intention is to
achieve a stable and high viscosity level,
without gels occurring to a significant degree;
the film should be producible in an economically viable manner;
the viscosity in the extrusion should vary to a minimum degree;
at the same time, the remaining (positive) properties of the film should be impaired to a minor degree or ideally not at all by the measures for increasing the viscosity.

These objects are achieved by a biaxially oriented polyester film which comprises a chain extender in addition to polyester.

The film comprises a polyester as the main constituent. Suitable polyesters are, for example, polyethylene terephthalate (PET), polyethylene naphthalate (PEN), polybutylene terephthalate (PBT), polytrimethylene terephthalate (PTT), bibenzoyl-modified polyethylene terephthalate (PETBB), bibenzoyl-modified polybutylene terephthalate (PBTBB), bibenzoyl-modified polyethylene naphthalate (PENBB) or mixtures thereof, preference being given to PET, PBT, PEN and PTT and mixtures and copolyesters thereof.

To prepare the polyesters, in addition to the main monomers such as dimethyl terephthalate (DMT), ethylene glycol (EG), propylene glycol (PG), 1,4-butanediol, terephthalic acid (TA), benzenedicarboxylic acid and/or 2,6-naphthalenedicarboxylic acid (NDA), it is also possible to use isophthalic acid (IPA), trans- and/or cis-1,4-cyclohexanedimethanol (c-CHDM, t-CHDM or c/t-CHDM), neopentyl glycol and other suitable dicarboxylic acid components (or dicarboxylic esters) and diol components.

Preference is given to polymers in which the dicarboxylic acid component consists of TA to an extent of 90% by weight (based on the total amount of the dicarboxylic acid component) and more, especially to an extent of 95% by weight and more. Preference is further given to thermoplastics in which the diol component consists of EG to an extent of 90% by weight and more, especially to an extent of 93% by weight (based on the total amount of the diols) and more. Preference is also given to polymers in which the diethylene glycol content in the overall polymer is in the range from 0.25 to 3% by weight. In all amounts stated in this paragraph, the chain extender is disregarded.

The film according to the invention may further comprise inorganic or organic particles which are required to adjust the surface topography or appearance (gloss, haze, etc.). Such particles are, for example, calcium carbonate, apatite, silicon dioxide, titanium dioxide, aluminum oxide, crosslinked polystyrene, crosslinked polymethyl methacrylate (PMMA), zeolites and other silicates such as aluminum silicates. These compounds are used generally in amounts of 0.05 to 5% by weight, preferably 0.1 to 0.6% by weight (based on the weight of the film). Particular preference is given to calcium carbonate and silicon dioxide.

To achieve good run reliability in production, the particle sizes d₅₀ used are generally between 0.1 and 20 μm and preferably between 0.3 and 7 μm and more preferably between 0.5 and 5 μm. Fibrous inorganic additives such as glass fibers are unsuitable, since they make the production of the polyester film uneconomic as a result of many breakoffs. The d₅₀ values reported are always based on the particle size of the particles before introduction into the polymer.

In a preferred embodiment, the film is white. Suitable white pigments are especially titanium dioxide, barium sulfate or incompatible polymers such as polypropylene, polyethylene or cycloolefin copolymers (COCs), or combinations thereof. These are added to the polyester appropriately to an extent of 1-35% by weight, the preferred amount added being between 2 and 20% by weight (based on the total weight of the film). In this embodiment, the film more preferably contains between 3 and 10% by weight (based on the total weight of the film) of white pigment. To achieve good run reliability and whiteness, the particle sizes d₅₀ used are generally between 0.05 and 5 μm and preferably between 0.1 and 1 μm (these stated parameters apply, however, only to inorganic white pigments).

In addition to the abovementioned additives, the film may additionally comprise further components such as flame retardants (preferably organic phosphoric esters) and/or antioxidants and/or UV stabilizers and/or IR absorbents. A selection of suitable antioxidants and UV stabilizers can be found, for example, in FR-A-28 12 299.

In addition, it has been found to be favorable when a stabilizer is added to the film in the form of a free-radical scavenger, since this counteracts the loss of active oxirane groups in the extrusion as a result of free-radical side reactions. Appropriately, the inventive film contains such stabilizers as free-radical scavengers or thermal stabilizers in amounts of 50 to 15 000 ppm, preferably 100 to 5000 ppm, more preferably 300 to 1000 ppm, based on the weight of the film. The stabilizers added to the polyester raw material are selected as desired from the group of the primary stabilizers such as sterically hindered phenols or secondary aromatic amines, or from the group of the secondary stabilizers such as thioethers, phosphites and phosphonites, and also zinc dibutyldithiocarbamate or synergistic mixtures of primary and secondary stabilizers. Preference is given to the phenolic stabilizers. The phenolic stabilizers include especially sterically hindered phenols, thiobisphenols, alkylidenebisphenols, alkylphenols, hydroxybenzyl compounds, acylaminophenols and hydroxyphenyl propionates (corresponding compounds are described, for example, in “Kunststoffadditive” [Plastics Additives], 2nd edition, Gächter Müller, Carl Hanser-Verlag, and in “Plastics Additives Handbook”, 5th edition, Dr. Hans Zweifel, Carl Hanser-Verlag). Particular preference is given to the stabilizers with the following CAS numbers: 6683-19-8, 36443-68-2, 35074-77-2, 65140-91-2, 23128-74-7, 41484-35-9, 2082-79-3, and also ®Irganox 1222 from Ciba Specialties, Basle, Switzerland, preference being given in particular embodiments to the ®Irganox 1010, ®Irganox 1222, ®Irganox 1330 and ®Irganox 1425 types or mixtures thereof.

According to the invention, the film comprises at least one chain extender.

Chain extenders are molecules with at least two reactive groups which can react with the polyesters during the extrusion and join polyester chains to one another, and whose reactive groups are already depleted substantially (i.e. to an extent of >75%) during the extrusion and are no longer available for a chain repair (extension) during the use of the polyester film after the production thereof.

Preferred chain extenders in the context of the invention are difunctional epoxides and more preferably polyfunctional epoxides (“functional” here describes the number of epoxy functions). The epoxy function is arranged terminally at the end of the molecule chain or of a side chain (=epoxidic chain extender).

The terminal epoxy functions are preferably described by formula 1.

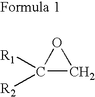

R₁ and R₂ may be any organic radicals (aliphatic or aromatic or combinations thereof), where R₁ is preferably H.

Polyfunctional epoxides are preferred over the bifunctional epoxides, since lower use amounts are required, higher molecular weight end products form and there is a lower level of gaseous cleavage products.

The number of epoxy groups in the molecule is greater than 1, preferably greater than 2 and more preferably greater than 5. The number of epoxy functions per molecule is typically <100, preferably <20 and ideally <10. The greater the number of epoxy functions, the greater the chain extension effect, but also the greater the tendency to form gel.

The epoxy equivalent weight in g/mol (molecular weight/number of epoxy functions) is typically >200, preferably >300 and ideally >425. It is typically <2000 and preferably <1000. The higher the epoxy equivalent weight, the lower the tendency to form gel. With rising epoxy equivalent weight, however, more in % by weight of the compound is required to achieve an effective viscosity rise.

The molecular weight of the epoxidic chain extenders is typically >1500, preferably >2000 and ideally >3000. It is typically <15 000, preferably <10 000 and ideally <5000. The best incorporation into the polyester matrix is achieved within the molecular weight range specified.

2S The epoxidic chain extenders are preferably liquid at room temperature, since the incorporation into the polyester is thus facilitated.

Molecular weight, number of epoxy groups and epoxy equivalent weight may be selected independently of one another. Particularly suitable chain extenders are those in which all three properties are within the ideal range.

Bisphenol-containing epoxides such as those of the Araldite series or the corresponding Epon products are less preferred, since they eliminate bisphenol A which was detectable in the ambient air.

Particularly preferred chain extenders in the context of the invention are polymers described by formula 2.

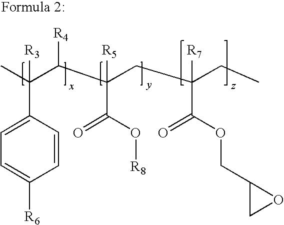

R₃-R₇ are each independently H or a C1-C12-alkyl radical, preferably —CH₃;
R₈ is a C1-C12-alkyl group, preferably CH₃;
x and y are independent of one another and are in the range from 0 to 100 and preferably in the range from 1 to 20;
x+y is greater than 0 and preferably greater than 10 and
z is in the range from 2 to 100, preferably in the range from 3 to 20 and more preferably in the range from 3 to 10.

These data are based on the mean of the polymers used, since individual polymer chains may have monomer components which differ from the preferred ranges distributed randomly therein.

These compounds are notable for particularly good incorporation into the polyester matrix and simultaneously have very good chain-extending action with a low tendency to form gel. This is especially true when at least two of the three monomers x, y and z are simultaneously within the preferred ranges.

Such polymers are sold by BASF under the Joncryl® ADR brand name. Particular preference is given to the liquid products.

These polymers are typically metered in in an amount of less than 2% by weight and more preferably in an amount of less than 1.2% by weight. Typically at least 0.05% by weight, preferably at least 0.1% by weight and more preferably at least 0.2% by weight (based on the total weight of the film) is metered in.

Epoxides suitable in principle are also co- or terpolymers of glycidyl methacrylate, ethylene and/or esters of acrylic acid. Such epoxides are sold, for example, under the Lotader® brand name by Arkema France. In this context, especially Lotader AX8840, AX8900 and AX8950 are suitable. However, polymers from the Lotader series which do not contain glycidyl groups are unsuitable. Especially unsuitable are polymers which, instead of the glycidyl groups, contain maleic anhydride-containing monomers. Generally, polymers containing maleic anhydride-containing monomers are less suitable, since they have a strong tendency to form gel and a low tendency to extend chains. One process technology disadvantage of the otherwise suitable compounds of the Lotader series is that they are solid at room temperature. They first have to melt in order to react and do not have good miscibility with the polyesters. As a result, relatively high use amounts of approximately >2% by weight, preferably >4% by weight (based on the total weight of the film), are required in order to achieve good stabilization of viscosity. With increasing dosage, however, there is an increasing risk of gel formation and an increasing risk of abrupt viscosity rises, with the risk of production shutdowns and in extreme cases even of damage to extrusion components. At a dosage of >10% by weight, there is significant gel formation.

In the case of dosage of the polymeric chain extenders, significant haze of the film was generally observed at a dosage above 2% (rise in haze by more than 2, reported in %). This is generally acceptable only in white or matt films, but is disadvantageous in clear embodiments.

Surprisingly, all other chain extenders proposed in general terms for polyesters are found to be substantially unsuitable in biaxially stretched polyester films.

Although bisoxazolines (such as 1,3-PBO from DSM (the Netherlands), sold under the Allinco brand name) led to a viscosity increase, there was simultaneously significant yellowing of the film and the particular oxazoline sweated out of the film, which led to deposits on the rollers in film production. Above 2% by weight, stable production was no longer possible. Bisoxazolines are therefore unsuitable as chain extenders in the context of the invention.

Carbonylbiscaprolactam (CBC) is likewise sold as a chain extender under the Allinco brand name by DSM (the Netherlands). CBC is effective in concentrations of 0.1 to 1.3% by weight (based on the total weight of the film). Below this the effect is too low and above it the result is gels and an abrupt viscosity rise in the extrusion. Contrary to expectations, however, CBC also resulted in sweating with deposits on rollers and in yellowing of the film. CBC and other carbonyllactams are therefore unsuitable as chain extenders in the context of the invention.

Polyfunctional anhydrides (polyanhydride and poly-functional mean here: a plurality of anhydride functions) have been described as chain extenders, both as an individual component and in combination with polyfunctional alcohols. Specific polyanhydrides and polyalcohols are described in EP-A-1 054 031. Preference is given there to using tetracarboxylic dianhydrides. Particular preference is given to pyromellitic dianhydride, especially also in combination with polyfunctional alcohols such as glycol and pentaerythritol, and phosphonates.

A chain extension effect was found both with polyfunctional anhydrides alone and in the combinations with alcohols. Surprisingly, however, the first visible gels occurred in the concentrations described in EP-A-1 054 031. In addition, the high hydrolysis rate of the resulting films was particularly surprising, said films having hydrolyzed about 15% faster than comparable films without chain extender and correspondingly also about 15% faster than films which contained the above-described preferred chain extenders (in the same effective active concentration).

Therefore, polyanhydrides, either alone or in combination with polyols and phosphonates, are not suitable chain extenders in the context of the invention.

The chain extenders are preferably metered directly into the extruder in the course of film production. It is particularly preferred when the viscosity of the melt is measured in the process (online) and the metering of the chain extender is regulated so as to achieve a constant viscosity in the extrusion.

However, the chain extender can also be added in the raw material production. A preferred point here is addition to the extrusion in the course of production of the regrind from the production residues of the film production. The SV of the regrind is appropriately adjusted via the metered addition of the chain extenders such that it corresponds to the mean SV of the other raw materials in the continued film production.

Preference is given to using multiscrew extruders (with at least 2 screws).

The chain extender can also be introduced via masterbatch technology. In other words, the chain extender(s) (together or separately) is/are introduced into the polymer in an extruder (preferably a multiscrew extruder). In the course of film production, this polymer is/these polymers are then mixed in pure form or together with other polymers and extruded again. However, this method is less preferred since chain extender is already consumed (depleted) in the first extrusion step and is then no longer available in the film as an active substance. Accordingly, particularly gentle extrusion conditions should be selected, which, unlike in the film production, do not lead to complete (i.e. >75%) depletion of the active groups. This can be achieved, for example, through the selection of copolyesters with a lower melting point (e.g. polymers with more than 5% by weight, preferably more than 10% by weight, of IPA (isophthalic acid)) and/or through a later addition of the chain extender in the extruder, i.e. not directly in the inlet region.

The film according to the invention is generally produced by extrusion processes known per se and has one or more layers, it being possible for the chain extender to be present in all layers, though embodiments in which not all layers are modified with the chain extender are also possible.

The film thickness is between 6 and 500 μm and preferably between 12 and 300 μm and more preferably between 36 and 200 μm.

In the process for producing the inventive films, the procedure is appropriately to extrude the corresponding melts through a flat die, to consolidate the film thus obtained by drawing it off and quenching it on one or more roll(s) (chill rolls) as a substantially amorphous preliminary film, then to reheat the film and biaxially stretch (orient) it and to heatset the biaxially stretched film. In the region of the extrusion, it has been found to be favorable when the extruder intake zone is not heated above 260° C., since there will otherwise be undesired reactions of the chain extenders as early as here.

The biaxial stretching is generally conducted sequentially. In this case, stretching is preferably effected first in longitudinal direction (i.e. in machine direction=MD) and then in transverse direction (i.e. at right angles to machine direction=TD). This leads to an orientation of the molecule chains. The stretching in longitudinal direction can be conducted with the aid of two rollers running at different speeds according to the desired stretching ratio. For the transverse stretching, an appropriate tenter frame is generally used.

The temperature at which the stretching is conducted may vary within a relatively wide range and is guided by the desired properties of the film. In general, the longitudinal stretching and also the transverse stretching are conducted at T_{g}+10° C. to T_{g}+60° C. (T_{g}=glass transition temperature of the film). The longitudinal stretching ratio is generally in the range from 2.0:1 to 6.0:1, preferably 3.0:1 to 4.5:1. The transverse stretching ratio is generally in the range from 2.0:1 to 5.0:1, preferably 3.0:1 to 4.5:1, and any second longitudinal and transverse stretching conducted is at 1.1:1 to 5.0:1.

The longitudinal stretching can optionally be conducted simultaneously with the transverse stretching (simultaneous stretching). It has been found to be particularly favorable here when the stretching ratio in longitudinal and transverse direction is in each case greater than 3.0.

The subsequent heatsetting involves keeping the film at a temperature of 150 to 260° C., preferably 200 to 245° C., for about 0.1 to 10 s. Following on from or commencing in the course of heatsetting, the film is relaxed by 0 to 15%, preferably by 1.5 to 8%, in transverse direction and optionally also in longitudinal direction, and then the film is cooled and wound in a customary manner.

Films which comprise the inventive chain extenders are suitable for virtually all typical applications of biaxially stretched polyester films, for electrical insulation films up to packaging. It is possible to add a significantly higher proportion of regrind without the process stability being affected. In the case of addition of the chain extender directly in the course of film extrusion, the process stability can be improved further. Both lead to considerable cost savings.

In the working examples which follow, the individual properties are measured by the standards and methods listed.

Test Methods

Standard Viscosity (SV)

The standard viscosity SV is—based on DIN 53726—measured by the measurement of the relative viscosity η_{rel.} of a 1% by weight solution in dichloroacetic acid (DCA) in an Ubbelohde viscometer at 25° C. The SV is defined as follows:

SV=(η_{rel.}−1)1000

Shrinkage

Thermal shrinkage is determined on square film specimens with an edge length of 10 cm. The samples are cut out such that one edge runs parallel to machine direction and one edge at right angles to machine direction. The samples are measured accurately (the edge length L₀ is determined for each machine direction TD and MD, L_{0 TD} and L_{0 MD}) and heat treated in a forced-air drying cabinet at the given shrinkage temperature (200° C. here) for 15 min. The samples are removed and measured accurately at room temperature (edge length L_{TD} and L_{MD}). The shrinkage is calculated from the equation

Shrinkage [%]MD=100(L_{0 MD}−L_{MD})/L_{0 MD}

Shrinkage [%]TD=100(L_{0 TD}−L_{TD})/L_{0 TD}

Measurement of Transparency

The measurement is effected on a Haze-gard Plus from BYK Gardner Instruments to ASTM D 1003.

Measurement of Transparency at 370 nm

The transparency is measured with a Lambda 3 UV/Vis spectrometer from Perkin Elmer.

Measurement of Density

Density can be determined in a gradient column (e.g. carbon tetrachloride and hexane) or by means of gas pycnometer (helium or nitrogen).

Measurement of the Mean Particle Diameter d₅₀ on Particles Before Introduction into the Raw Material

The determination of the mean particle diameter d₅₀ was conducted by means of a laser on a Master Sizer (Malvern Instruments, UK) by the standard method (other measuring instruments are, for example, Horiba LA 500 (Horiba Ltd., Japan) or Helos (Sympatec GmbH, Germany), which use the same measurement principle). For this purpose, the samples were placed with water into a cuvette which was then placed into the measuring instrument. The measuring operation is automatic and also includes the mathematical determination of the d₅₀. By definition, the d₅₀ is determined from the (relative) cumulative curve of the particle size distribution: the point of intersection of the 50% ordinate value with the cumulative curve provides the desired d₅₀ on the abscissa axis.

Measurement of the Mechanical Properties of the Film

The mechanical properties are determined to DIN EN ISO 527-1 to 3.

Autoclaving

The films (10×2 cm) are hung on a wire in the autoclave (Adolf Wolf SANOklav ST-MCS-204) and the autoclave is filled with 2 l of water. After the autoclave has been closed, it is heated. At 100° C., the air is displaced through the outlet valve by the water vapor. The valve is closed after approx. 5 min, and then the temperature rises to 110° C. and the pressure to 1.2-1.5 bar. After the set time, the autoclave is automatically switched off and, after the outlet valve has been opened, the films are withdrawn. The SV is then determined thereon.

### EXAMPLES

Chain Extender 1

Joncryl 4380 (liquid at room temperature) with a molecular weight of 3300 and an epoxy equivalent weight of 450 g/mol. Joncryl 4380 corresponds to formula 2 with the variables in the orders of magnitude specified there.

Chain Extender 2

1,3-PBO (1,3-phenylenebisoxazoline, Allinco from DSM Netherlands).

Further Raw Materials Used
Raw material R1 PET (Invista Deutschland), SV 790 and a carboxyl end group content of 22 mmol/kg and a diethylene glycol content of 0.75% by weight.
Masterbatch MB1 20% by weight of TiO₂ (Hombitan LW-SU from Sachtleben Germany) and 80% by weight of PET; SV 790; DEG of 1% by weight and a carboxyl end group content of 42 mmol/kg (addition of TiO₂ by incorporation in a twin-screw extruder).

Film Production:

Thermoplastic chips (MB1 and R1) were mixed according to the conditions specified in the examples and extruded at 278° C. in a twin-screw extruder (JapanSteelWorks). The chain extenders were metered directly into the extruder intake by means of a peristaltic pump (chain extender 1) or by means of a vibrating gutter (chain extender 2). The viscosity of the polymer is measured in the melt and the metered addition of the chain extenders was matched to the viscosity by ±15%. The molten polymer was drawn off from a die by means of a draw roller. The film was stretched at 116° C. by a factor of 3.4 in machine direction and transverse stretching by a factor of 3.3 was conducted at 110° C. in a frame. Subsequently, the film was heatset at 225° C. and relaxed in transverse direction by 6% at temperatures of 200 to 180° C. The final film thickness was 50 μm.

The example formulations and the properties of the films produced can be taken from the table which follows.

In contrast to Example 1, the film from Comparative example 1 shows yellowing clearly discernible to the eye, and deposits formed on several rollers (draw rollers and stretching rollers), which were identifiable as 1,3 PBO and degradation products.

While the above-described automatic metering correction of ±15% in Example 1 was sufficient to establish a very homogeneous viscosity in the melt, several clear jumps to higher viscosities, which led to breakoffs in the process, arose in Comparative example 1. The hydrolysis rate from Example 1 corresponded to the hydrolysis rate (loss of SV units per hour in the autoclave) of a film made from the same raw materials without chain extender (Comparative example 2). The hydrolysis rate of the film from Comparative example 1 is 10% higher.

TABLE

| | | | Comparative | Comparative |
|---|---|---|---|---|
| | | Example 1 | example 1 | example 2 |
| R1 | in % by | 19.5 | 19.2 | 20 |
| | wt. | | | |
| MB1 | in % by | 10 | 10 | 10 |
| | wt. | | | |
| Own regrind (this | in % by | 70 | 70 | 70 |
| involves chopping the | wt. | | | |
| film, feeding the | | | | |
| chips to a twin-screw | | | | |
| extruder, melting, | | | | |
| extruding through a | | | | |
| perforated die and | | | | |
| pelletizing again) | | | | |
| Chain extender 1 | in % by | 0.5 | 0 | 0 |
| | wt. | | | |
| Chain extender 2 | in % by | 0 | 0.8 | 0 |
| | wt. | | | |
| Film thickness | in μm | 50 | 50 | 50 |
| SV (after film | | 791 | 790 | 685 |
| production) | | | | |

1. A biaxially oriented polyester film which comprises a chain extender in addition to polyester.

2. The polyester film as claimed in claim 1, wherein said polyester film is white.

3. The polyester film as claimed in claim 1, wherein said polyester film comprises one or more additives selected from the group consisting of: inorganic particles, organic particles, flame retardants, free-radical scavengers, antioxidants, IR absorbents and UV stabilizers.

4. The polyester film as claimed in claim 1, wherein the chain extender is a molecule with at least two reactive groups that react with the polyesters during extrusion and join polyester chains to one another, said reactive groups substantially depleted during extrusion and no longer available for a chain repair and/or extension after the polyester film production.

5. The polyester film as claimed in claim 1, wherein the chain extender is an at least difunctional epoxide with an epoxy function arranged terminally at the end of the difunctional epoxide molecule chain or a difunctional epoxide side chain.

6. The polyester film as claimed in claim 5, wherein the chain extender comprises a number of epoxy groups in the chain extender molecule, said number ranging from >1 and <100.

7. The polyester film as claimed in claim 1, wherein the chain extender has an epoxy equivalent weight of the chain extender in g/mol, molecular weight/number of epoxy functions, of >200 and <2000.

8. The polyester film as claimed in claim 1, wherein the chain extender has a molecular weight of >1500 and <15 000.

9. The polyester film as claimed in claim 1, wherein the chain extender is liquid at a temperature of 25° C.

10. The polyester film as claimed in claim 1, wherein the chain extender is a compound of the formula 1: 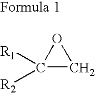
where
R₁ is H or any aliphatic or aromatic organic radical and
R₂ is any aliphatic or aromatic organic radical.

11. The polyester film as claimed in claim 1, wherein the chain extender is a polymer of the formula 2: 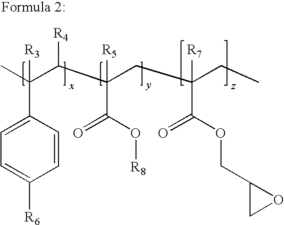
where
R₃—R₇ are each independently H or a C1-C12-alkyl radical;
R₈ is a C1-C12-alkyl group;
x and y are independent of one another and are each a number from 0 to 100;
x+y is greater than 0 and
z is from 2 to 100.

12. The polyester film as claimed in claim 1, wherein the chain extender is present in the film in an amount ranging from at least 0.05% by weight to less than 2% by weight, based on the total weight of the film.

13. A process for producing a polyester film as claimed in claim 1 comprising
(i) extruding melt compositions corresponding to the film through a flat die,
(ii) consolidating the film thus obtained by drawing it off
(iii) quenching the consolidated film on one or more chill rolls to form a substantially amorphous preliminary film,
(iv) orienting the preliminary film by reheating and biaxially stretching the preliminary film and
(v) heat-setting and rolling up the biaxially stretched film, wherein the film comprises a chain extender.

14. Outdoor film, ribbon cable, backside laminate of solar modules or electrical insulation film comprising a polyester film as claimed in claim 1.
